(19) United States
(12) Patent Application Publication
(10) Pub. No.: US 2017/0147033 A1
(43) Pub. Date: May 25, 2017

(54) Wearable Ring Control Device

(71) Applicant: Gustav Y. Pastorino, Fremont, CA (US)

(72) Inventor: Gustav Y. Pastorino, Fremont, CA (US)

(21) Appl. No.: 14/952,764

(22) Filed: Nov. 25, 2015

(51) Int. Cl. G06F 1/16; G05G 1/08; G05B 15/02

(52) U.S. Cl. CPC G06F 1/163; G05B 15/02; G05G 1/08

(57) ABSTRACT

A wearable ring control device is an apparatus to control the functionality of wirelessly connective devices. The wearable ring control device includes an annular housing, a wireless transceiver, an annular dial at least one ergonomic button, and a central processing unit (CPU). The annular housing fits over a finger of the user. The dial is engaged with the adjacent fingers, and the movement data activates and executes commands to relay to another device, wirelessly. The at least one ergonomic button and the annular dial are externally integrated within the annular housing. The user interfaces with the annular dial with adjacent fingers, and the at least one ergonomic button which when actuated communicate a signal through the CPU and subsequently through the wireless transceiver in order to be received and translated by a wireless communication device to control a functionality of the wireless communication device.

### FIELD OF THE INVENTION

The present invention relates generally to a wearable control device accessory. More specifically, the present invention relates to a ring accessory, which relay control signals to a wireless device in order to manipulate a function of the wireless device.

### BACKGROUND OF THE INVENTION

Finger-worn rings have been around for a long time, and have both a symbolic affect, and some have practical purposes. The ring is such that it can easily rotate around the ring finger by means of moving adjacent fingers in opposite directions through friction. The present invention for a ring seeks to expand on this recordable movement, and with our current level of technology this motion can be translated into information which can be sent wirelessly to electronic devices to execute commands. There is simplicity in the motion of rotating a ring around a finger, so this ring technology can be used for someone with limited mobility. The present invention can also be implemented by someone who is in a compromised position and needs the simplicity of motion in communicating rotational movement information, executing a command to an associated device.

With an increase in wireless computing devices, such as tablets, smart phones, laptops and speakers, people have increasing means to interact with audio media, video media, and communications technology. How we interact with them encompasses a need for detailed motions, as with position specific technology, for design and art, but there is also a need for simplistic and convenient motions, like changing volume settings, or changing the channel on a television, or answering or declining a phone call. For instance, patients in long-term care sometimes cannot find their remote to change the channel on their television. Wearing a ring that can change the channel or change a volume setting with ease of rotating a dial on a ring with one or two other adjacent fingers could increase a person's quality of life.

There are abundant applications for tethering this simplistic, merely two or three-finger controlled ring design to other technologies, where simplicity of motions is the goal. Activating alarms for security personnel, increasing or decreasing controlled dosing machines in medicine, for pain management. Answering a phone call for someone riding a motorcycle, driving a car, a plane, or anything else, where minimizing motion would be beneficial in answering and receiving calls, and many more.

With the dial motion for utilizing this device design, there is a selectivity in when the ring will convey information to another wireless device. This dialing motion can be set up so that there is a certain motion that activates the ring, like a combination lock, and then the ring will be able to send the command information to the desired device or devices.

### BRIEF DESCRIPTION OF THE DRAWINGS

FIG. 1 is a perspective view of the present invention including a battery charging port.

FIG. 2 is a front view of the present invention including a battery charging port and a power indication light.

FIG. 3 is a top view of the present invention.

FIG. 4 is a perspective view for an alternate embodiment of the present invention including a setting.

FIG. 5 is front view of the alternate embodiment of the present invention including a setting and a power indication light.

FIG. 6 is an exploded perspective view for an embodiment of the present invention, where the annular housing includes a first interlocking annulus and a second interlocking annulus.

FIG. 7 is a front schematic view of the present invention.

FIG. 8 is a front schematic view for the embodiment of the present invention including a setting where the battery is internally positioned within the annular housing.

FIG. 9 is a front schematic view for the embodiment of the present invention including a setting where the battery is internally positioned within the setting.

FIG. 10 is a top schematic view of the present invention exemplifying the electrical connections for the power button and the pairing button.

FIG. 11 is a perspective view for an alternate embodiment of the present invention where the annular dial extends out from the annular housing.

FIG. 12 is a top view for the alternate embodiment of the present invention where the annular dial extends out from the annular housing.

### DETAIL DESCRIPTIONS OF THE INVENTION

All illustrations of the drawings are for the purpose of describing selected versions of the present invention and are not intended to limit the scope of the present invention.

The present invention is a wearable ring control device. The present invention is worn on the finger of a user such that it is conveniently and easily accessible. The present invention communicates a control signal to a wireless device in order to manipulate functionality of a wireless computing device such as adjusting a volume output, switching music tracks and accepting or rejecting incoming calls, as well as general controls for the wireless computing device when applicable.

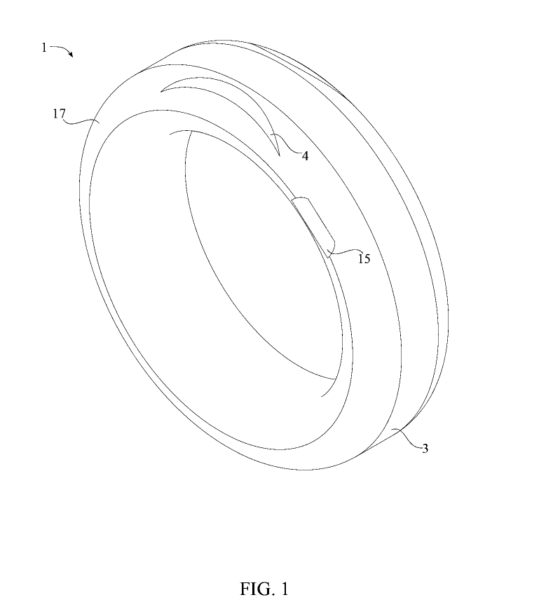

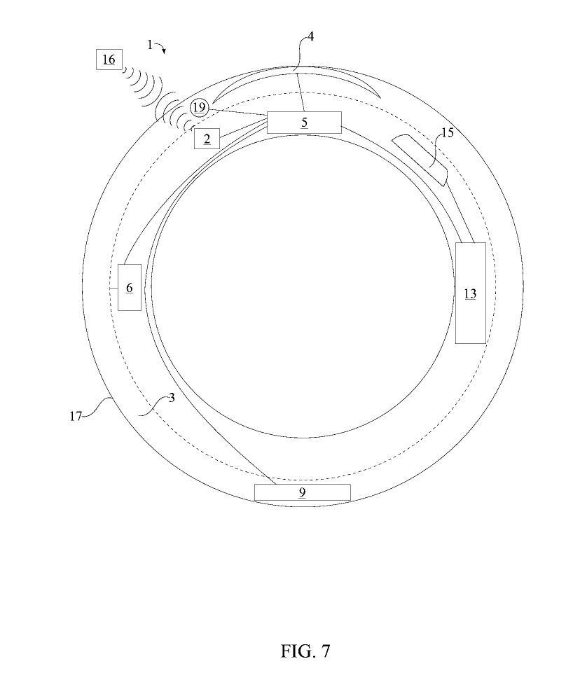

The present invention comprises an annular housing 1, a wireless transceiver 2, an annular dial 3, and a central processing unit (CPU) 5, as shown in FIG. 7. The annular housing 1 allows the present invention to be worn on a finger, mounted onto a necklace, or affixed in a similar manner as traditional ring accessories. The wireless transceiver 2 allows the present invention to communicate with a wireless computing device 16, such as a mobile phone, tablet, laptop, wireless connective media players, etc., in order to manipulate the functionality of the wireless computing device 16. In accordance to FIG. 1, the annular dial 3 is rotatably integrated into the annular housing 1 in order to allow for incremental control for functions of the wireless computing device 16, such as volume output. The annular dial 3 is positioned on an external lateral surface 17 of the annular housing 1 such that the annular dial 3 is easily accessible to the user. The user is able to use their adjacent fingers or opposite hand to easily actuate the annular dial 3.

In accordance to the preferred embodiment, the present invention comprises at least one ergonomic button 4. The at least one ergonomic button 4 allows the user such functionalities as toggling power through the present invention and pairing the present invention with the wireless computing device 16. The at least one ergonomic button 4 is laterally mounted into the annular housing 1 and positioned adjacent to the annular dial 3 such that conveniently and easily manipulated by the user.

In accordance the preferred embodiment and FIG. 7 to FIG. 9, the wireless transceiver 2, annular dial 3, and the at least one ergonomic button 4 are electronically connected to the CPU 5. Through the CPU 5, a user input is communicated from the manipulation of the annular dial 3 or the at least one ergonomic button 4 to the wireless transceiver 2. The wireless transceiver 2 transmits the user input to the wireless computing device 16. The wireless transceiver 2 and the CPU 5 are internally mounted within the annular housing 1 such that the ring aesthetic is maintained by the present invention.

In accordance to the preferred embodiment, the present invention comprises an orientation sensor 6, as shown in FIG. 7 to FIG. 9. The orientation sensor 6 is operatively coupled with the annular dial 3, wherein the orientation sensor 6 detects the angular position of the annular dial 3 in order to assess the rotation and position of the annular dial 3. The orientation sensor 6 is mounted within the annular housing 1, to maintain the ring aesthetic of the present invention. The orientation sensor 6 is electronically coupled to the CPU 5 in order to translate the rotation of the annular dial 3 into a communicable signal to be transmitted through the wireless transceiver 2. The wireless transceiver 2 is communicatively coupled to the wireless computing device 16 such that the communicable signal is receivable by the wireless computing device 16. The wireless transceiver 2 is capable of short range transmission including, but not limited to, radio frequency, Bluetooth, Wi-Fi, or similar communication methods.

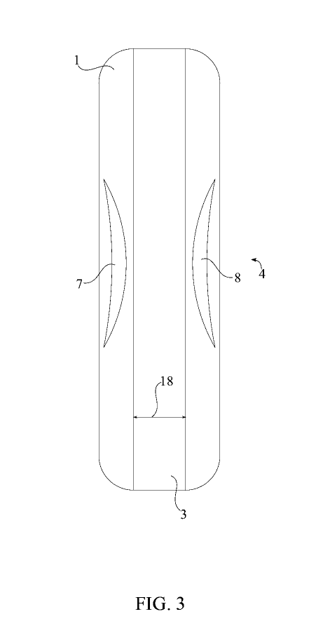

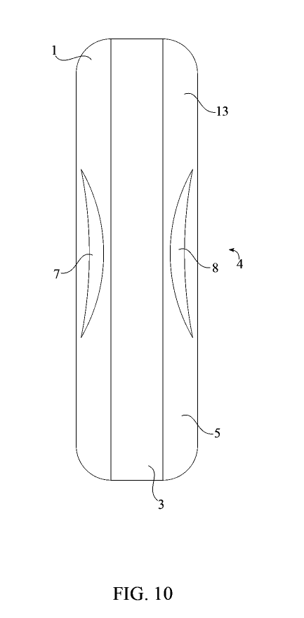

Further in accordance to the preferred embodiment, the at least one ergonomic button 4 comprises a power button 7 and a pairing button 8, as detailed in FIG. 3 and FIG. 10. The power button 7 toggles current flow from a battery 13 to the CPU 5 and subsequently to the other electronic components of the present invention. The pairing button 8 syncs the present invention with the wireless computing device 16 such that the communicable signal emitted from the wireless transceiver 2 is received by the wireless computing device 16. The power button 7 and the pairing button 8 are positioned opposite to each other across a lateral width 18 of the annular dial 3, as shown in FIG. 3. The power button 7 and the pairing button 8 are preferred to be crescent shaped such that the power button 7 and the pairing button 8 contour to a fingertip. In accordance to FIG. 10, the power button 7 is electrically connected to the battery 13. Similarly, the CPU 5 is electrically connected to the power button 7 such that the power button 7 is able to toggle the current from the battery 13 to the CPU 5 on and off. The pairing button 8 is electrically connected to the CPU 5 in order to receive electricity as well as toggle a signal to the wireless transceiver 2 in order to synchronize the present invention with the wireless computing device 16.

In some embodiments of the present invention, the present invention comprises at least one pressure sensor 9, as shown in FIG. 7 to FIG. 9. The at least one pressure sensor 9 provides additional control functionalities without taking away from the ring aesthetic. The at least one pressure sensor 9 is internally mounted within the annular housing 1 and positioned adjacently to the external lateral surface 17, such that tapping the present invention onto a surface or applying pressure from an adjacent finger actuates the at least one pressure sensor 9. The at least one pressure sensor 9 is electronically connected to the CPU 5, such that the CPU 5 receives a signal from the actuation of the at least one pressure sensor 9. As the at least one pressure sensor 9 is actuated, the CPU 5 receives a signal from the at least one pressure sensor 9 to be transmitted by the wireless transceiver 2 to the wireless computing device 16 which interprets the signal.

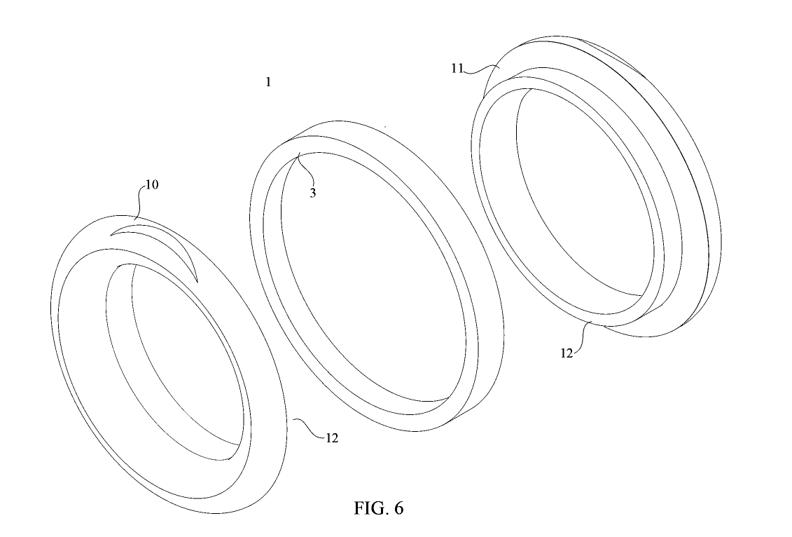

In still other embodiments of the present invention, the annular housing 1 comprises a first interlocking annulus 10 and a second interlocking annulus 11 as shown in FIG. 6. The first interlocking annulus 10 and the second interlocking annulus 11 each comprise an interlocking interface 12. The interlocking interface 12 of the first interlocking annulus 10 is sealably engaged by the interlocking interface 12 of the second interlocking annulus. This configuration allows for the first interlocking annulus 10 to be separable from the second interlocking annulus 11 allowing access to the internal components of the present invention for repair or modification. The first interlocking annulus 10 and the second interlocking annulus 11 are sealably engaged to each other in order to provide a water resistant seal to prevent damage to electrical components. The annular dial 3 is positioned around the interlocking interface 12 of the first interlocking annulus 10 and interlocking interface 12 of the second interlocking annulus 11, in order to conceal the separation point between the first interlocking annulus 10 and the second interlocking annulus 11.

Due to the inclusion of electrical components, the present invention necessarily comprises a battery 13, as shown in FIG. 7 to FIG. 10. The battery 13 provides a source of electricity for the electrical components. The battery 13 is electrically and directly connected to the CPU 5 and, therefore, the battery 13 is subsequently connected to the wireless transceiver 2, the at least one ergonomic button 4, the orientation sensor 6, and the at least one pressure sensor 9 through the CPU 5.

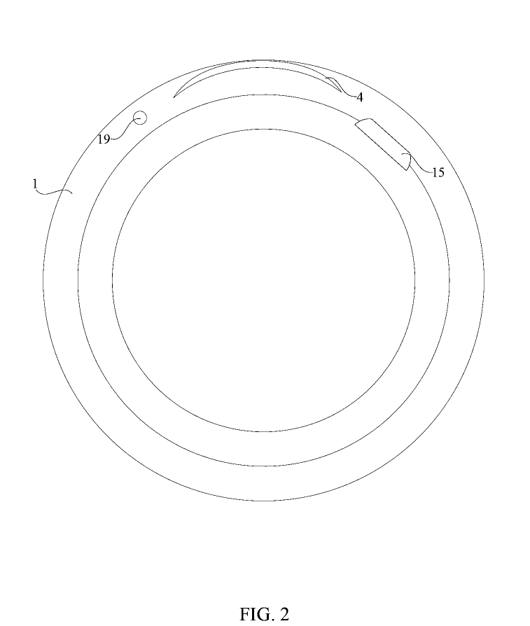

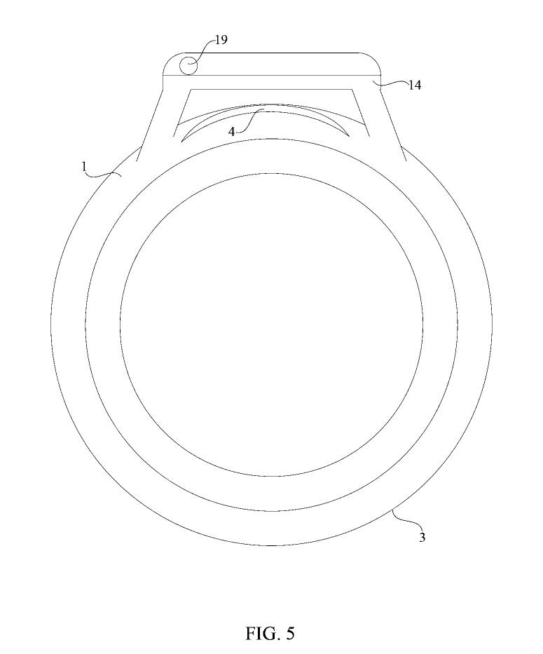

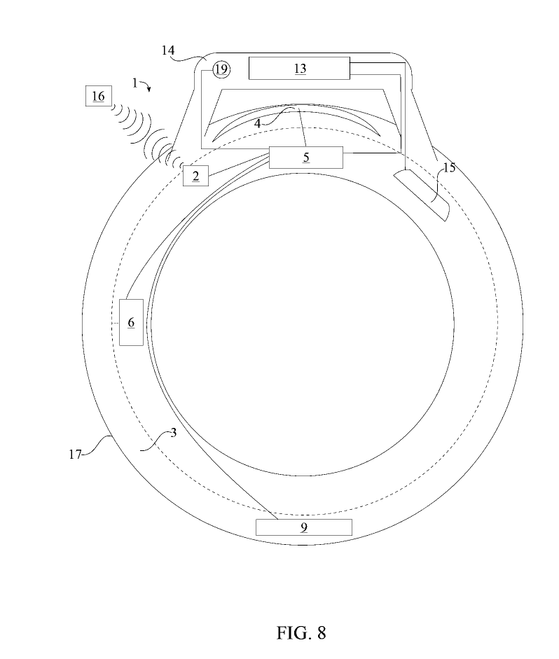

In some embodiments, the present invention comprises a power indication light 19 in order to indicate to the user when the remaining charge of the battery 13 is below a predetermined threshold, in accordance to FIG. 2, FIG. 5, FIG. 7, and FIG. 8. The power indication light 19 electrically connected to the CPU 5, as shown in FIG. 7 and FIG. 8. As the CPU 5 assesses the charge of the battery 13, the current is toggled to the power indication light 19 to illuminate in order to alert the user to exchange or recharge the batter 13 when the charge of the battery 13 drops below the predetermined threshold. In accordance to the preferred embodiment, the power indication light 19 is integrated into annular housing 1 in order to be easily visible to the user, as shown in FIG. 2.

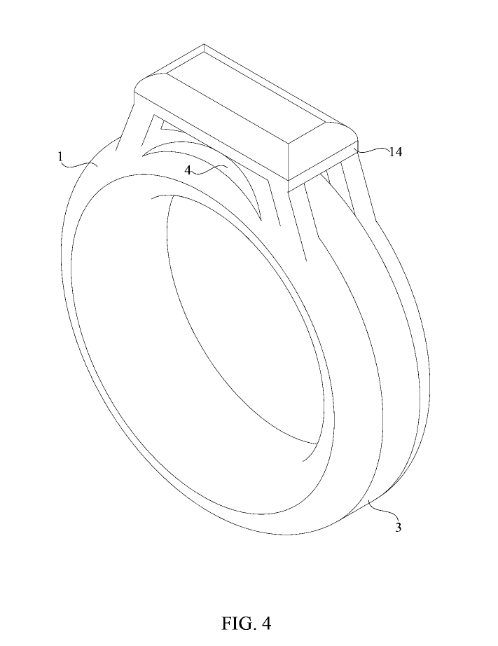

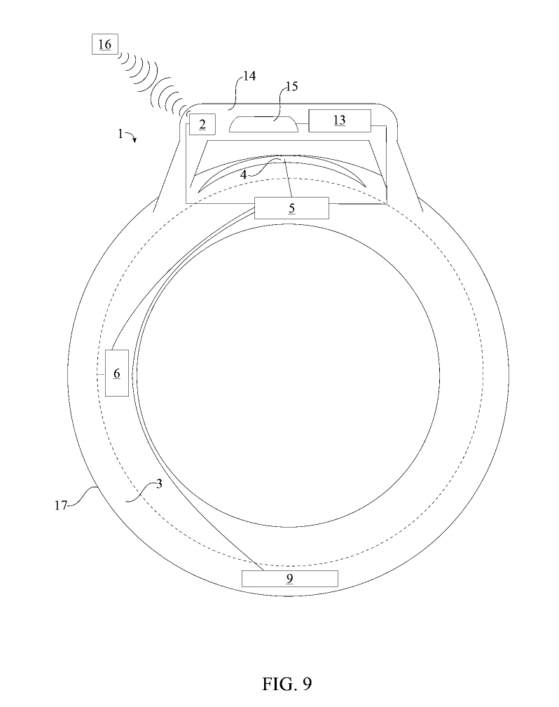

In accordance to some embodiments of the present invention, the present invention comprises a setting 14 as shown in FIG. 4, FIG. 5, FIG. 8, and FIG. 9. The setting 14 is similar to traditional jewelry settings in that the setting 14 affixes the battery 13 onto the present invention as a precious gem is inset into traditional jewelry settings. In accordance to FIG. 4, the setting 14 is externally mounted onto the annular housing 1 about the annular dial 3 such that the annular dial 3 is free to rotate around the annular housing 1. The setting 14 is offset from the annular dial 3 as to prevent friction between the annular dial 3 and the setting 14. In accordance to FIG. 8 and FIG. 9, the battery 13 is mounted into the setting 14 in order to secure the battery 13 to the present invention maintaining the jewelry aesthetic while providing a convenient place to mount batteries which are too large to be mounted within the annular housing 1. Within some of these embodiments, the battery 13 is rechargeable. Within these embodiments comprising a rechargeable battery 13, the present invention comprises a battery charging port 15. The battery charging port 15 allows for the battery 13 to be recharged from an external power source. The battery charging port 15 is integrated into the setting 14 where the battery charging port 15 is electrically connected to the battery 13 in order to restore electrical charge to the battery. In accordance to some other embodiments of the present invention, the battery 13 is internally mounted within the annular housing 1 to maintain a setting-less ring aesthetic, as shown in FIG. 9.

Within both the embodiment including a setting 14 and the embodiment where the battery 13 is internally mounted, there are some embodiments when the battery 13 is rechargeable. In accordance to these embodiments, the present invention comprises a battery charging port 15 which is integrated into the annular housing 1. The battery charging port 15 is electrically connected to the battery 13 in order to restore the electrical charge to the battery 13, as shown in FIG. 2, FIG. 7 and FIG. 8.

In some embodiments of the present invention comprising a setting 14, the wireless transceiver 2 is internally mounted within the setting 14 in order to reduce signal interference from the user's adjacent fingers to the one which the present invention is worn, as shown in FIG. 9. In some other embodiments of the present invention comprising a setting 14, the present invention comprises a power indication light 19. The power indication light 19 is integrated into the setting 14 in order to be easily visible to the user, in accordance to FIG. 8. As the setting 14 typically extends away from the palm of the user, this positioning of the power indicator light 19 on the setting 14 allows the power indicator light 19 to be easily visible on the present invention.

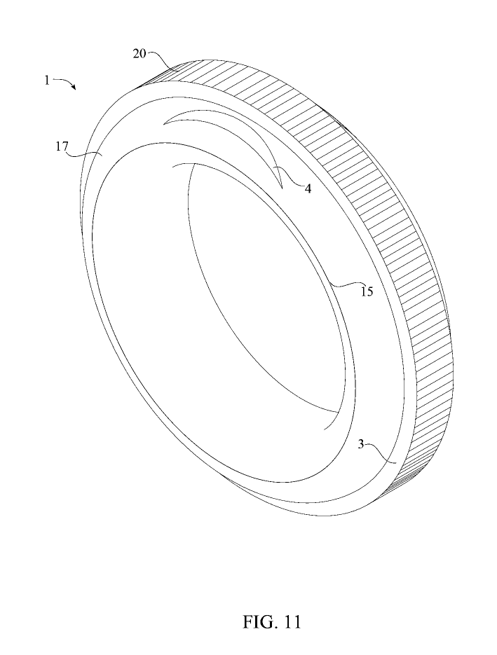

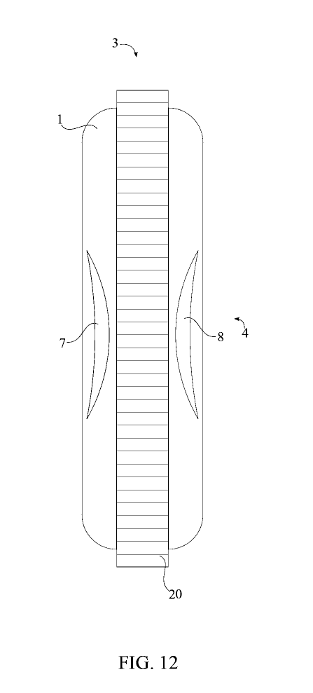

In some embodiments, the annular dial 3 extends out from the annular housing 1 in order to be more easily accessible to the user's adjacent fingers, in accordance to FIG. 11 and FIG. 12. To further help the user manipulate the annular dial 3, in some other embodiments of the present invention, the present invention comprises a grip 20. The grip is mounted onto the annular dial 3 opposite to the annular housing 1. The grip 20 increases the coefficient of friction between the user's fingers and the annular dial 3 in order to make the annular dial 3 easier manipulated by the user's adjacent fingers. The grip 20 may be formed from knurling the annular dial 3, a tactile coating, tape or any other suitable frictional surface which may be superimposed or integrated onto the exterior of the annular dial 3 such that the coefficient of friction between the user's fingers and the annular dial 3 is increased.

Although the invention has been explained in relation to its preferred embodiment, it is to be understood that many other possible modifications and variations can be made without departing from the spirit and scope of the invention as hereinafter claimed.

What is claimed is:

1. A wearable ring control device comprising:
an annular housing;
a wireless transceiver;
an annular dial;
a central processing unit (CPU);
the annular dial being rotatably integrated into the annular housing;
the annular dial being positioned on an external lateral surface of the annular housing; and
the annular dial and the wireless transceiver being electronically connected to the CPU.

2. The wearable ring control device, as claimed in claim 1, comprising:
the wireless transceiver and the CPU being internally mounted within the annular housing.

3. The wearable ring control device, as claimed in claim 1, comprising:
at least one ergonomic button;
the at least one ergonomic button being laterally mounted into the annular housing;
the at least one ergonomic button being positioned adjacent to the annular dial; and
the at least one ergonomic button being electronically connected to the CPU.

4. The wearable ring control device, as claimed in claim 3, comprising:
the at least one ergonomic button comprises a power button and a pairing button;
the power button and the pairing button being positioned opposite to each other across a lateral width of the annular dial;
the power button being electrically connected to the battery;
the CPU being electrically connected to the power button; and
the pairing button being electronically connected to the CPU.

5. The wearable ring control device, as claimed in claim 1, comprising:
an orientation sensor;
the orientation sensor being internally mounted within the annular housing;
the orientation sensor being operatively coupled with the annular dial, wherein the orientation sensor detects the angular position of the annular dial; and
the orientation sensor being electronically coupled to the CPU.

6. The wearable ring control device, as claimed in claim 1, comprising:
at least one pressure sensor;
the at least one pressure sensor being internally mounted within the annular housing;
the at least one pressure sensor being positioned adjacent to the external lateral surface; and
the at least one pressure sensor being electronically connected to the CPU.

7. The wearable ring control device, as claimed in claim 1, comprising:
the annular housing comprises a first interlocking annulus and a second interlocking annulus;
the first interlocking annulus and the second interlocking annulus each comprise an interlocking interface;
the interlocking interface of the first interlocking annulus being sealably engaged by the interlocking interface of the second interlocking annulus; and
the annular dial being positioned around the interlocking interface of the first interlocking annulus and the interlocking interface of the second interlocking annulus.

8. The wearable ring control device, as claimed in claim 1, comprising:
a setting;
the setting being externally mounted onto the annular housing about the annular dial;
the setting being positioned offset from the annular dial;

9. The wearable ring control device, as claimed in claim 8, comprising:
the wireless transceiver being internally mounted within the setting.

10. The wearable ring control device, as claimed in claim 8, comprising:
a battery;
the battery being mounted into the setting; and
the battery being electrically connected to the CPU.

11. The wearable ring control device, as claimed in claim 10, comprising:
a power indication light;
the power indication light being electrically connected to the CPU; and
the power indication light being integrated into the setting.

12. The wearable ring control device, as claimed in claim 10, comprising:
a battery charging port;
the battery being rechargeable;
the battery charging port being integrated into the setting; and
the battery charging port being electrically connected to the battery.

13. The wearable ring control device, as claimed in claim 10, comprising:
a battery charging port;
the battery being rechargeable;
the battery charging port being integrated into the annular housing; and
the battery charging port being electrically connected to the battery.

14. The wearable ring control device, as claimed in claim 1, comprising:
a battery;
the battery being internally mounted within the annular housing; and
the battery being electrically connected to the CPU.

15. The wearable ring control device, as claimed in claim 14, comprising:
a power indication light;
the power indication light being electrically connected to the CPU; and
the power indication light being laterally integrated into the annular housing.

16. The wearable ring control device, as claimed in claim 14, comprising:
a battery charging port;
the battery being rechargeable;
the battery charging port being integrated into the annular housing; and
the battery charging port being electrically connected to the battery.

17. The wearable ring control device, as claimed in claim 1, comprising:
a wireless computing device; and
the wireless transmitter being communicatively coupled to the wireless computing device.

18. The wearable ring control device, as claimed in claim 1, comprising:
the annular dial extending out from the annular housing;

19. The wearable ring control device, as claimed in claim 1, comprising:
a grip;
the grip being mounted onto the annular dial;
the grip being positioned opposite to the annular housing; [symbol]
